(19) United States
(12) Patent Application Publication
(10) Pub. No.: US 2005/0198662 A1
(43) Pub. Date: Sep. 8, 2005

(54) Content distribution system

(75) Inventors: Hidehiro Endo, Tokyo (JP); Toshiya Okabe, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/066,392

(22) Filed: Feb. 28, 2005

(30) Foreign Application Priority Data
Mar. 2, 2004 (JP) 057732/2004

(51) Int. Cl. H04N 7/025; H04N 7/167; H04N 7/16; H04N 7/10

(52) U.S. Cl. 725/31; 725/25; 380/200; 380/210

(57) ABSTRACT

The content distribution system of the invention changes over the content distribution destination between terminals which have different content receiving formats. The terminals comprise means for requesting, while viewing content from a broadcasting station, changeover of distribution of this content to another terminal. The broadcasting station comprises means for changing over the content distribution destination on the basis of the aforesaid request. The content distribution system of the invention also comprises means for deciding on the distribution format of content in accordance with the type of aforesaid other terminal, which corresponds to the destination to which content distribution is to be changed over to by the changeover means. The means for deciding on distribution format comprises for example means which distributes content by scrambled broadcast when the aforesaid other terminal is a set-top box, and which encrypts content by means of codec conversion when the other terminal is a terminal connected in a broadband environment.

### BACKGROUND OF THE INVENTION

1. Field of the Invention

The present invention relates to techniques for changing over the destination of content distribution. The invention is particularly suited to utilization for distribution destination changeover between a set-top box (STB) and a terminal that is connected in a broadband environment.

2. Description of Related Art

Subscription broadcasting, a product of the spread of digital broadcasting, enables a user to view content upon insertion of an IC card, such as a B-CAS card in Japan, in an STB installed in a fixed location. However, changing over a subscription broadcast that is currently being viewed at a terminal such as an STB, to an arbitrary different communication terminal, and then viewing the broadcast content at the new terminal, has not been implemented.

For example, art for changing over the content distribution destination has been disclosed in JP2003-070042A, according to which content that is being distributed to one terminal can be distributed to another terminal as well, in accordance with a request from that other terminal. However, if application of this art to STBs is considered, the content distribution destination cannot be changed over to another terminal by means of a request from an STB when that STB is currently viewing content.

That is to say, in order to establish a service mode in which a user, during content distribution, changes over the distribution destination of that content to an arbitrary terminal and then continues to view the content, it is important, for the maintenance of user convenience, to be able to issue a changeover request from any terminal that is capable of receiving the content in question. However, there is no such proposal in JP2003-070042A.

Moreover, in subscription broadcasting, broadcasts are scrambled or encoded by encryption so that content can be viewed only at the terminal of a user who has paid a fee, but the art disclosed in JP2003-070042A does not correspond to such subscription broadcasting.

That is to say, taking the example of broadcasts that are received by an STB, these broadcasts are scrambled and can be decoded and viewed using the terminal of a user who has paid a fee for the content. If, in the course of this viewing, the content distribution destination terminal is to be changed over to a terminal connected to a broadband environment, then it is no longer possible to use a scrambled broadcast, and instead it becomes necessary to encrypt the content by means of codec conversion, which is suited to the broadband environment. However, such art is not proposed in JP2003-070042A.

Moreover, after a changeover has been made, unless viewing of content at the pre-changeover terminal is made impossible, a plurality of terminals will be able to view content, which hinders the business operations of the content distributor. However, no concern regarding this point is expressed in JP2003-070042A.

### SUMMARY OF THE INVENTION

In the light of such background art, it is an object of the present invention to provide a content distribution system capable of changing over the content distribution destination between terminals which have different content receiving formats.

A specific feature of the present invention is that it provides mechanisms whereby, in a subscription broadcasting service, (i) different kinds of receiving apparatus (including STBs, broadband connected personal computers, and wireless local area network terminals (including PDC terminals)) can be used to purchase program viewing and to view programs; (ii) viewing-capable terminals can be changed over; and (iii) as a result of this changeover, viewing is impossible by the pre-changeover terminal.

That is to say, according to a first aspect the present invention is a content distribution system characterized in that: it comprises a broadcasting station for distributing content and a plurality of terminals for receiving this content; wherein these terminals comprise means for requesting changeover of distribution of the content to another terminal while viewing the content from the broadcasting station; the broadcasting station comprises means for changing over the content distribution destination on the basis of this request; and this content distribution system comprises means for deciding on the distribution format of the content in accordance with the type of the aforesaid other terminal, which corresponds to the destination to which content distribution is changed over to by the changeover means.

The aforesaid means for deciding on distribution format comprises for example means which decides to distribute content by scrambled broadcast when the aforesaid other terminal is a set-top box, and which decides to distribute content by encoded broadcast that has been encrypted by codec conversion when the aforesaid other terminal is a terminal connected in a broadband environment.

The content distribution system of the invention can also comprise means for periodically changing the scrambling pattern of the scrambled broadcast or the encryption pattern of the encoded broadcast, and their decoding information.

As a result, if for example a user who is currently viewing a subscription broadcast by means of an STB, wishes to continue to view the content of this subscription broadcast at another location by means of for example a wireless local area network (WLAN) terminal, that viewer can, via the STB, request the broadcasting station to change over the content distribution destination. Moreover, if the content distribution destination is changed over from an STB to a WLAN terminal, the content distribution format is automatically changed from the previous scrambled broadcast to distribution that is encrypted by codec conversion.

Moreover, by periodically changing the scrambling pattern or the encryption pattern, and their decoding information, and by not informing, after terminal changeover, the pre-changeover terminal of the decoding information, it is possible to eliminate situations where content can be viewed simultaneously at both the pre-changeover terminal and the post-changeover terminal.

Alternatively, the content distribution system of the present invention is characterized in that: it comprises a broadcasting station for distributing content and a plurality of terminals for receiving this content; wherein these terminals comprise means for requesting changeover of distribution of the content to the local terminal while another terminal is viewing the content from the broadcasting station; the broadcasting station comprises means for changing over the content distribution destination on the basis of this request; and this content distribution system comprises means for deciding on the distribution format of the content in accordance with the type of the aforesaid local terminal, which corresponds to the destination to which content distribution is changed over to by the changeover means.

The aforesaid means for deciding on distribution format comprises for example means which decides to distribute content by scrambled broadcast when the aforesaid local terminal is a set-top box, and which decides to distribute content by encoded broadcast that has been encrypted by codec conversion when the aforesaid local terminal is a terminal connected in a broadband environment.

The content distribution system of the invention can also comprise means for periodically changing the scrambling pattern of the scrambled broadcast or the encryption pattern of the encoded broadcast, and their decoding information.

As a result, if for example a user who is currently viewing a subscription broadcast by means of an STB, wishes to continue to view the content of that subscription broadcast at another location by means of for example a WLAN terminal, that viewer can, via a WLAN terminal prearranged to become the destination of the content distribution changeover, request the broadcasting station to change over the content distribution destination. Moreover, if the content distribution destination is changed over from an STB to a WLAN terminal, the content distribution format is automatically changed from the previous scrambled broadcast to distribution that is encrypted by codec conversion.

Moreover, by periodically changing the scrambling pattern or the encryption pattern, and their decoding information, and by not informing, after terminal changeover, the pre-changeover terminal of the decoding information, it is possible to eliminate situations where content can be viewed simultaneously at both the pre-changeover terminal and the post-changeover terminal.

The aforesaid terminals can also comprise means for displaying, in correspondence with information relating to the terminal which is currently receiving content, information relating to a terminal which can become a destination to which distribution of content is changed.

As a result, a user who for example is currently viewing a subscription broadcast by means of an STB, can select, from a plurality of WLAN terminals, the terminal which will become the destination of a content distribution changeover. If WLAN terminals are installed at a plurality of locations, the user can change over the content distribution destination by specifying a WLAN terminal that is installed in a place to which the user is scheduled to move.

If, in response to a request from a WLAN terminal, the distribution destination of content currently being distributed to an STB is to be changed over to the local terminal (i.e., to the WLAN terminal making the request), this local terminal can confirm in advance whether or not it can be the content distribution destination.

According to a second aspect, the present invention is a broadcasting station which is applicable to the content distribution system of the present invention.

According to a third aspect, the present invention is a terminal which is applicable to the content distribution system of the present invention.

The present invention is advantageous in that it enables changeover of content distribution destination between terminals having different content receiving formats.

### BRIEF DESCRIPTION OF THE DRAWINGS

Specific embodiments of the present invention will now be described, by way of example only, with reference to the accompanying drawings in which:

FIG. 1 shows the configuration of a content distribution system according to a first embodiment of the invention;

FIG. 2 shows an output screen of a television receiver during terminal changeover in the first embodiment;

FIG. 3 is a sequence diagram of the operation of the content distribution system of the first embodiment;

FIG. 4 is a sequence diagram of the operation of a content distribution system according to a second embodiment of the invention;

FIG. 5 shows an output screen of a display during terminal changeover in the second embodiment;

FIG. 6 shows the configuration of a content distribution system according to a third embodiment of the invention;

FIG. 7 is a sequence diagram of the operation of the content distribution system of the third embodiment; and

FIG. 8 is a sequence diagram of the operation of a content distribution system according to a fourth embodiment of the invention.

### DETAILED DESCRIPTION OF THE PREFERRED EMBODIMENTS

### First Embodiment

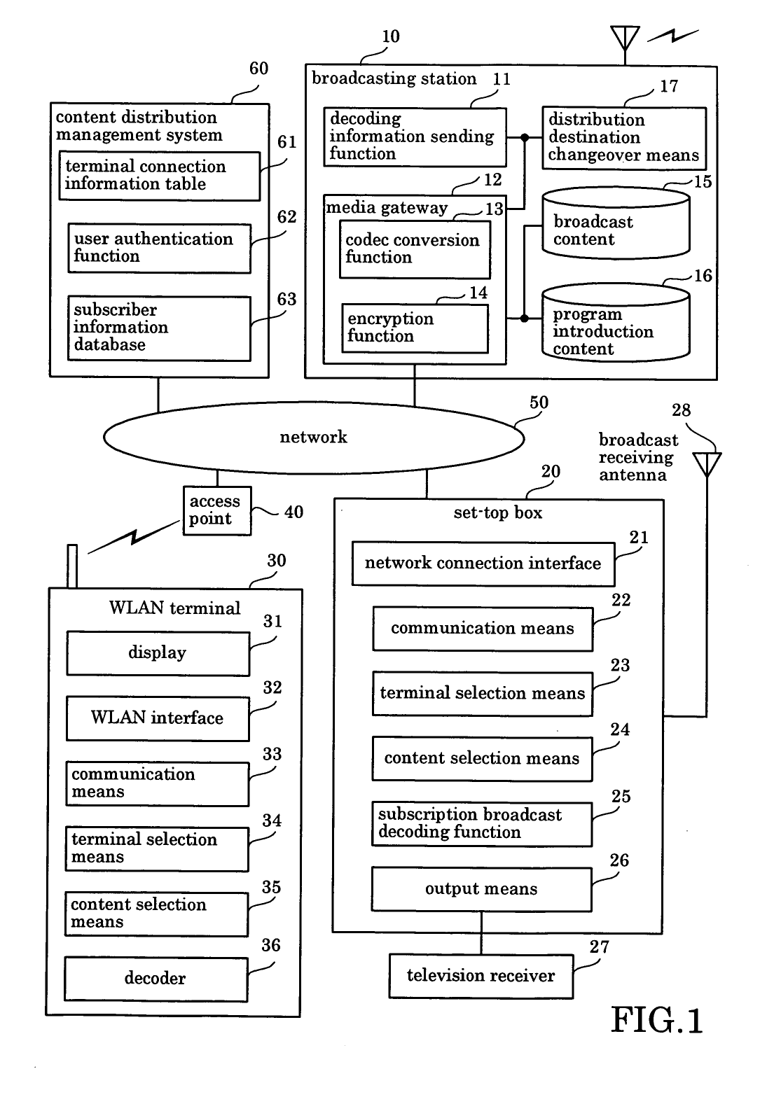

The configuration of a content distribution system according to a first embodiment of the present invention will be described with reference to FIG. 1.

As shown in FIG. 1, the content distribution system of the first embodiment comprises broadcasting station 10 for distributing content, and STB 20 and WLAN terminal 30 for receiving this content. STB 20 comprises terminal selection means 23 for requesting, while viewing content from broadcasting station 10, a changeover of distribution of that content to WLAN terminal 30. Broadcasting station 10 comprises distribution destination changeover means 17 for changing over the content distribution destination on the basis of the aforesaid request. This distribution destination changeover means 17 comprises means for deciding on the distribution format of the content in question in accordance with WLAN terminal 30, which corresponds to the content distribution destination to which changeover is to be made.

Distribution destination changeover means 17 comprises means for distributing content by scrambled broadcast when the distribution destination terminal is STB 20, and for encrypting the content by codec conversion using media gateway (MG) 12 when the distribution destination terminal is WLAN terminal 30.

Codec conversion function 13, encryption function 14 and decoding information sending function 11 also comprise means for periodically changing the scrambling pattern of the scrambled broadcast, or the encryption pattern of the encoded broadcast, and their decoding information.

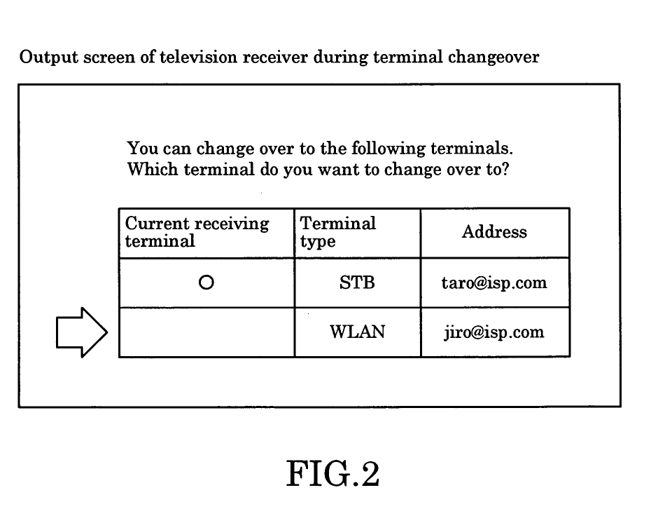

As shown in FIG. 2, STB 20 further comprises means for displaying, in correspondence with information relating to the terminal which is currently receiving content, information relating to a terminal which can become a destination to which distribution of content is changed.

The first embodiment is described in greater detail below.

The situation described in this first embodiment is one in which a subscription broadcast program which it is desired to view via STB 20 is purchased on a pay-per-view basis, and the receiving terminal is changed over to WLAN terminal 30 in the course of viewing the program. In this first embodiment, the changeover request is made from STB 20, via which the program is initially being viewed.

The content distribution system of the first embodiment further comprises, as shown in FIG. 1, antenna 28 for receiving broadcasts; STB 20 connectable to a network and capable of decoding received broadcasts; television set 27 for showing images that have been sent from STB 20; broadcasting station 10 for providing broadcast content; access point (AP) 40; WLAN terminal 30; network 50 comprising the Internet Protocol, telecommunication circuits, etc. and serving to connect access point 40, STB 20 and broadcasting station 10; and content distribution management system 60 comprising terminal connection information table 61 for storing information relating to terminals connected to network 50, user authentication function 62 for authenticating terminal users, and subscriber information database 63 for handling billing for the broadcaster.

Broadcasting station 10 further comprises decoding information sending function 11 for periodically sending decoding information, media gateway 12 for codec conversion and encryption of data to be distributed, broadcast content 15, and program introduction content 16 for introducing content in advance with the purpose of getting subscribers to purchase broadcast content.

STB 20 further comprises interface 21 for connecting to the network; communication means 22 for communicating with various devices in the network and for receiving broadcasts in the form of radiowaves; terminal selection means 23 for selecting a terminal to which changeover is to be made; content selection means 24 for selecting, via a screen, content which the user wishes to view; subscription broadcast decoding function 25 for decoding subscription broadcasts received in scrambled form; and output means 26 for outputting to a television receiver the decoded broadcast content.

Similarly, WLAN terminal 30 comprises WLAN interface 32; communication means 33 for communicating with various devices in the network; decoder 36 for decrypting encrypted distributed content; terminal selection means 34 for selecting a terminal to which changeover is to be made; content selection means 35 for selecting, via a screen, content which the user wishes to view; and display 31.

In this first embodiment, the combination of access point (AP) and WLAN terminal may also be a personal computer, or other terminal capable of receiving video, connected in a broadband environment.

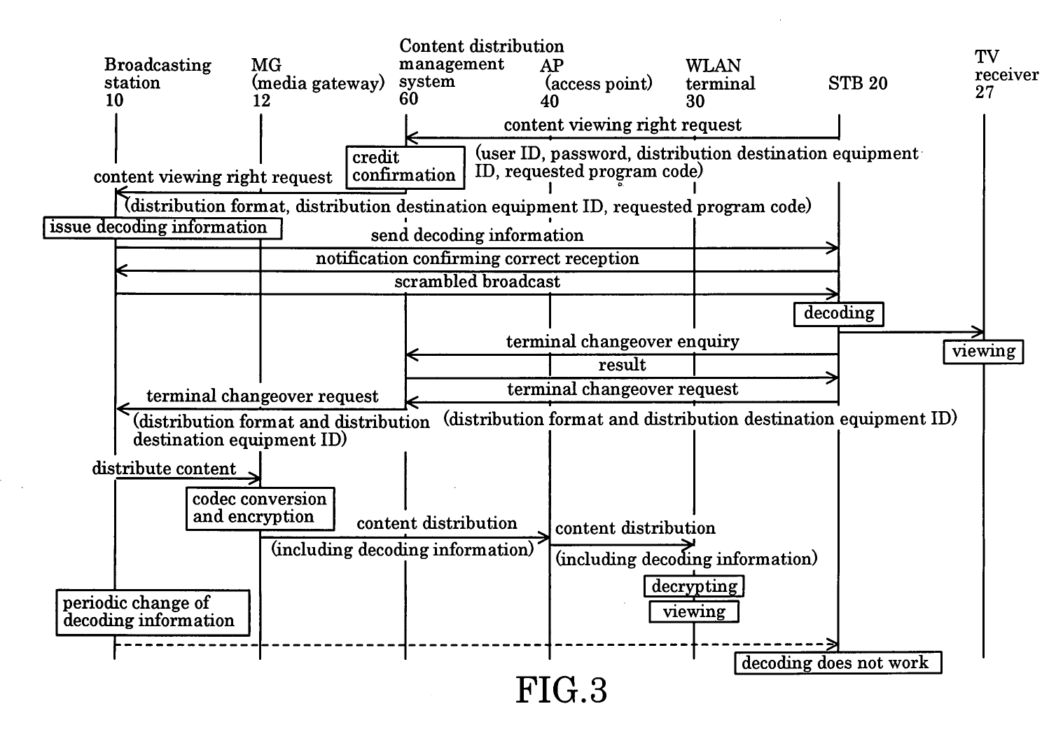

The operation of the content distribution system of this first embodiment will be described with reference to FIG. 3, which is a sequence diagram of this operation.

Firstly, a description will be given of the operation up to beginning to view a subscription broadcast by means of STB 20. Content selection means 24 of STB 20 specifies, by way of the user's television receiver 27, a particular pay-per-view subscription broadcast which broadcasting station 10 is advertising in a broadcast, and a request to purchase a right to view the specified content is sent from STB 20 to content distribution management system 60. At this juncture, the user ID, a password, the distribution destination equipment ID (e.g., an IP address) and the requested program code are transmitted.

When content distribution management system 60 has received this request via the network, it confirms the credit of the user who has requested the purchase (e.g., whether or not that user has the ability to pay the required amount). After credit confirmation has been completed satisfactorily, content distribution management system 60 issues a content distribution request to broadcasting station 10, this request including distribution format (scrambled broadcast, MPEG2, MPEG4, etc.), distribution destination equipment ID, and requested program code. When broadcasting station 10 receives the content distribution request, it issues the decoding information required to descramble the specified scrambled subscription broadcast, and sends this information to STB 20 via the network.

When STB 20 has correctly received this, it sends notification confirming reception to broadcasting station 10. As a result of having received the decoding information, the user of STB 20 can use STB 20 to descramble the scrambled broadcast and can then view it on television receiver 27.

Next, a description will be given of the operation of changing over the receiving terminal from STB 20 to WLAN terminal 30. While viewing is proceeding via STB 20, STB 20 enquires of content distribution management system 60 whether there is a receiving terminal to which changeover can be made. STB 20 then receives the result of this enquiry. At this time, as shown in FIG. 2, the present receiving terminal and a receiving terminal to which changeover can be made are displayed on television receiver 27. A terminal to which changeover is desired is selected from this display. In the present example, the receiving terminal prior to changeover is STB 20 having taro@isp.com as its ID, and the terminal which can be selected for changeover is WLAN terminal 30 having jiro@isp.com as its ID. A request is therefore made to change over to this latter terminal.

When content distribution management system 60 receives this request, it determines the terminal that is the destination of the changeover and makes a receiving terminal changeover request (including distribution method and distribution destination equipment ID) to broadcasting station 10. When the broadcasting station receives this request, it uses media gateway (MG) 12 to convert and encrypt the subscription broadcast which the user is viewing to an encoded broadcast that the requested terminal can receive (e.g., to MPEG2 or MPEG4), and distributes the result to WLAN terminal 30.

Decoding information for decrypting is also distributed to WLAN terminal 30. WLAN terminal 30 decrypts the encrypted distributed data on the basis of this decoding information, and thereby becomes able to view it.

Next, a description will be given of the mechanism for ensuring that after the changeover of content distribution from STB 20 to WLAN terminal 30, the content in question cannot be viewed by STB 20. Broadcasting station 10 periodically (e.g., at 15 minute intervals) changes the scrambling pattern of its scrambled broadcast and the related decoding information. After changeover of the receiving terminal, the decoding information is not updated at STB 20, thereby ensuring that STB 20 cannot continue to view content.

As a result, after the terminal changeover it is only WLAN terminal 30 which is able to view the content for which the viewing right has been purchased, and hence it is possible to avoid the situation where a subscription broadcast ends up being viewed by two or more terminals.

### Second Embodiment

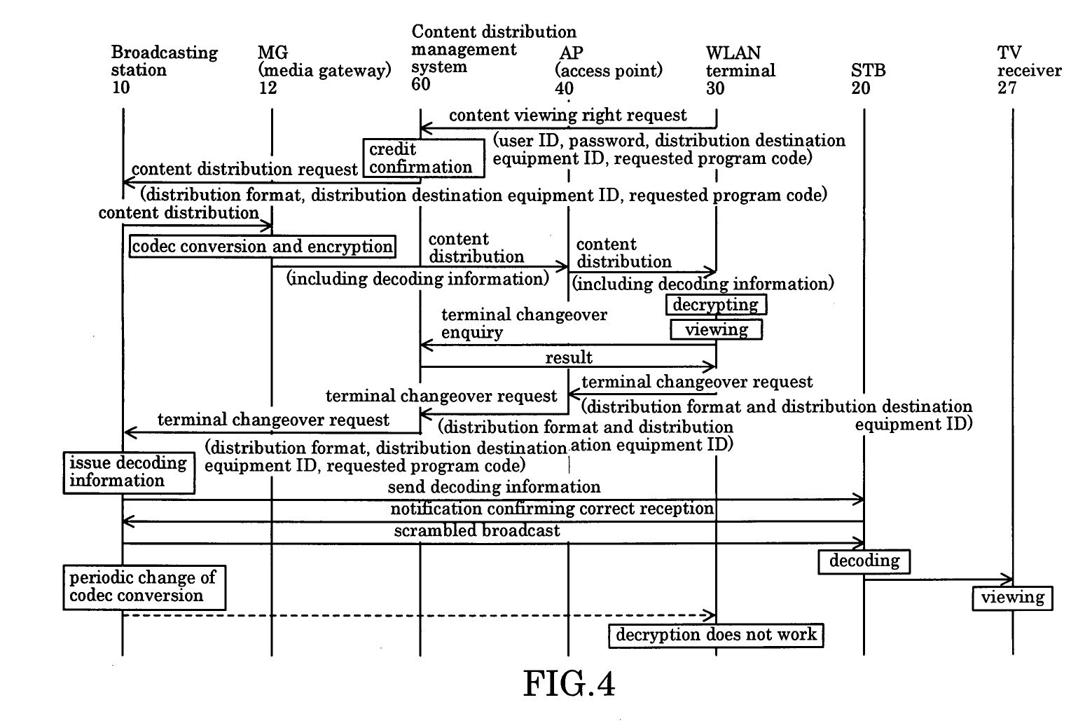

The operation of a content distribution system according to a second embodiment of the present invention will be described with reference to FIG. 4, which is a sequence diagram of this operation.

A description will be given, with reference to FIG. 4, of the procedure for changing over the content distribution destination from WLAN terminal 30 to STB 20. Firstly, a description will be given of the operation up to beginning to view a subscription broadcast by means of WLAN terminal 30. Content selection means 35 specifies, by way of display 31 of the user's WLAN terminal 30, a particular pay-per-view subscription broadcast which broadcasting station 10 is advertising on the network, and a request to purchase a right to view the specified content is sent from WLAN terminal 30 to content distribution management system 60. At this juncture, the user ID, a password, the distribution destination equipment ID (e.g., an IP address) and the requested program code are transmitted.

When content distribution management system 60 receives this request via the network, it confirms the credit of the user who has requested the purchase (e.g., whether or not that user has the ability to pay the required amount). After credit confirmation has been completed satisfactorily, content distribution management system 60 issues a content distribution request to broadcasting station 10, this request including distribution format (scrambled broadcast, MPEG2, MPEG4, etc.), distribution destination equipment ID, and requested program code. When broadcasting station 10 receives the content distribution request, it uses MG 12 to encrypt, by means of codec conversion, the content to be distributed, and then distributes the encrypted content. As well as distributing content, broadcasting station 10 issues the decoding information required to decrypt the encrypted content, and sends this information to WLAN terminal 30 along with the content.

As a result of having received the decoding information, the user of WLAN terminal 30 can decrypt the encrypted content and can then view it on display 31.

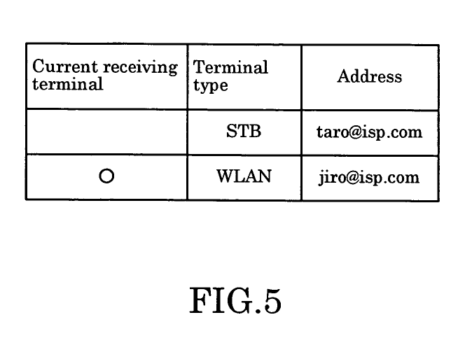

Next, a description will be given of the operation of changing over the receiving terminal from WLAN terminal 30 to STB 20. While viewing is proceeding via WLAN terminal 30, WLAN terminal 30 inquires of content distribution management system 60 whether there is a receiving terminal to which changeover can be made. WLAN terminal 30 then receives the result of this enquiry. At this time, as shown in FIG. 5, the present receiving terminal and a receiving terminal to which changeover can be made are displayed on display 31. A terminal to which changeover is desired is selected from this display. In the present example, the receiving terminal prior to changeover is WLAN terminal 30 having jiro@isp.com as its ID, and the terminal which can be selected for changeover is STB 20 having taro?isp.com as its ID. A request is therefore made to change over to this latter terminal.

When content distribution management system 60 receives this request, it determines the terminal that is the destination of the changeover and makes a receiving terminal changeover request (including distribution format and distribution destination equipment ID) to broadcasting station 10. When the broadcasting station has received this request and recognized that the changeover destination is STB 20, it issues the decoding information required to descramble the scrambling scheme employed for the specified subscription broadcast, and sends this information to STB 20 via the network.

When STB 20 has correctly received this, it sends notification confirming reception to broadcasting station 10. As a result of having received the decoding information, the user of STB 20 can use STB 20 to descramble the scrambled broadcast and can then view it on television receiver 27.

Next, a description will be given of the mechanism for ensuring that after the changeover of the content distribution destination from WLAN terminal 30 to STB 20, the content in question cannot be viewed by WLAN terminal 30. Broadcasting station 10 periodically (e.g., at 15 minute intervals) changes the codec conversion used to encrypt the content. After changeover of the receiving terminal, the decoding information is not updated at WLAN terminal 30, thereby ensuring that decrypting of encrypted content is rendered ineffective, so that WLAN terminal 30 cannot continue to view content.

As a result, after the terminal changeover it is only STB 20 which is able to view the content for which the viewing right has been purchased, and hence it is possible to avoid the situation where a subscription broadcast ends up being viewed by two or more terminals.

Hence subscription broadcast viewing rights can be transferred between terminals of different types.

### Third Embodiment

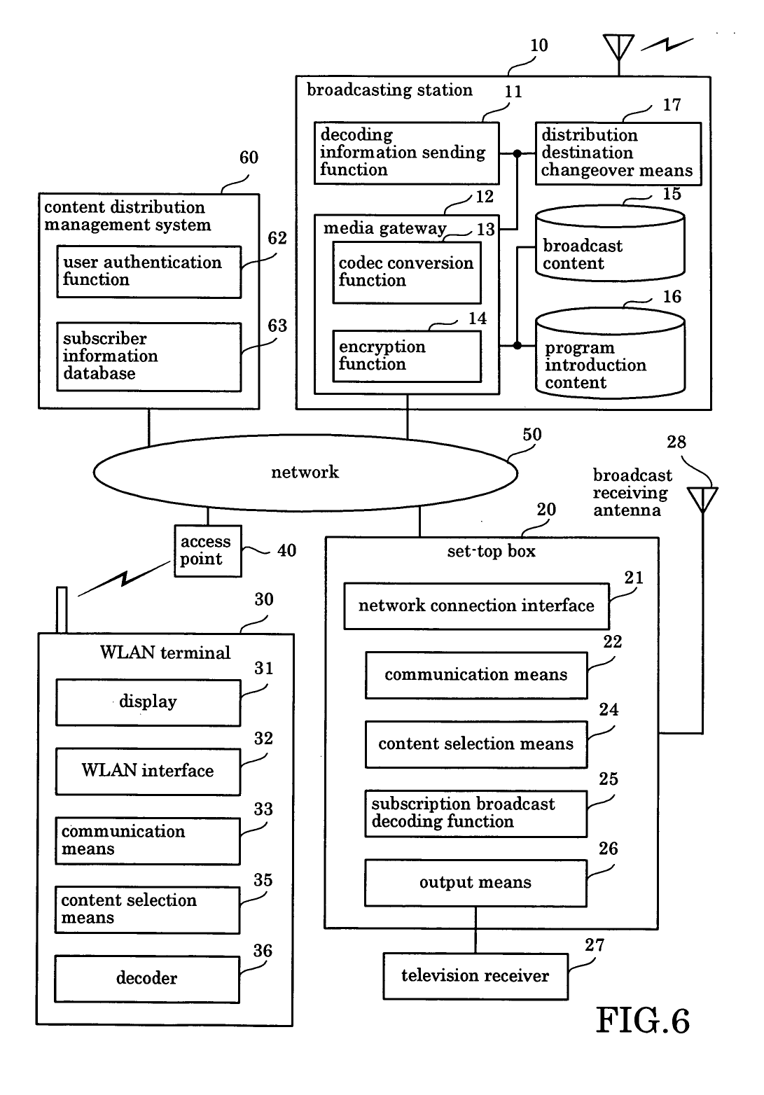

The configuration of a content distribution system according to a third embodiment of the present invention will be described with reference to FIG. 6, which shows the configuration of this system.

As shown in FIG. 6, the content distribution system of the third embodiment comprises broadcasting station 10 for distributing content, and STB 20 and WLAN terminal 30 for receiving this content. WLAN terminal 30 comprises means for requesting, while STB 20 is viewing content from broadcasting station 10, a changeover of distribution of that content to the local terminal, i.e., to WLAN terminal 30. Broadcasting station 10 comprises distribution destination changeover means 17 for changing over the content distribution destination on the basis of the aforesaid request. This distribution destination changeover means 17 comprises means for deciding on the distribution format of the content in question in accordance with WLAN terminal 30, which corresponds to the content distribution destination to which changeover is to be made.

Distribution destination changeover means 17 comprises means for distributing content by scrambled broadcast when the distribution destination terminal is STB 20, and for encrypting the content by codec conversion using MG 12 when the distribution destination terminal is WLAN terminal 30.

Codec conversion function 13, encryption function 14 and decoding information sending function 11 also comprise means for periodically changing the scrambling pattern of the scrambled broadcast, or the encryption pattern of the encoded broadcast, and their decoding information.

The third embodiment is described in greater detail below.

The constituent elements of the third embodiment differ from those of the first embodiment depicted in FIG. 1 in that, as shown in FIG. 6, terminal connection information table 61 in content distribution management system 60, and terminal selection means 23 and 34 in STB 20 and WLAN terminal 30, are not required. These were functions required to enable a terminal which was originally in process of viewing a subscription broadcast to select another terminal to be the destination of a changeover, there being a plurality of such other terminals. However, such functions are not necessary in the third embodiment, because the terminal which will become the changeover destination itself makes the changeover request. As a result, the third embodiment has the advantage of making the configuration of content distribution management system 60 and WLAN terminal 30 simpler than in the first and second embodiments.

On the other hand, if the same constituent elements as those of the first and second embodiments are provided, and terminal information of the sort shown in FIG. 2 or FIG. 5 displayed, then a terminal which will become the changeover destination will itself be able to confirm whether or not it is a terminal capable of becoming the changeover destination. A further consequence of this is that it is not necessary to include distribution format information each time a changeover request is made. Accordingly, the third embodiment encompasses provision of the same constituent elements as those of the first and second embodiments.

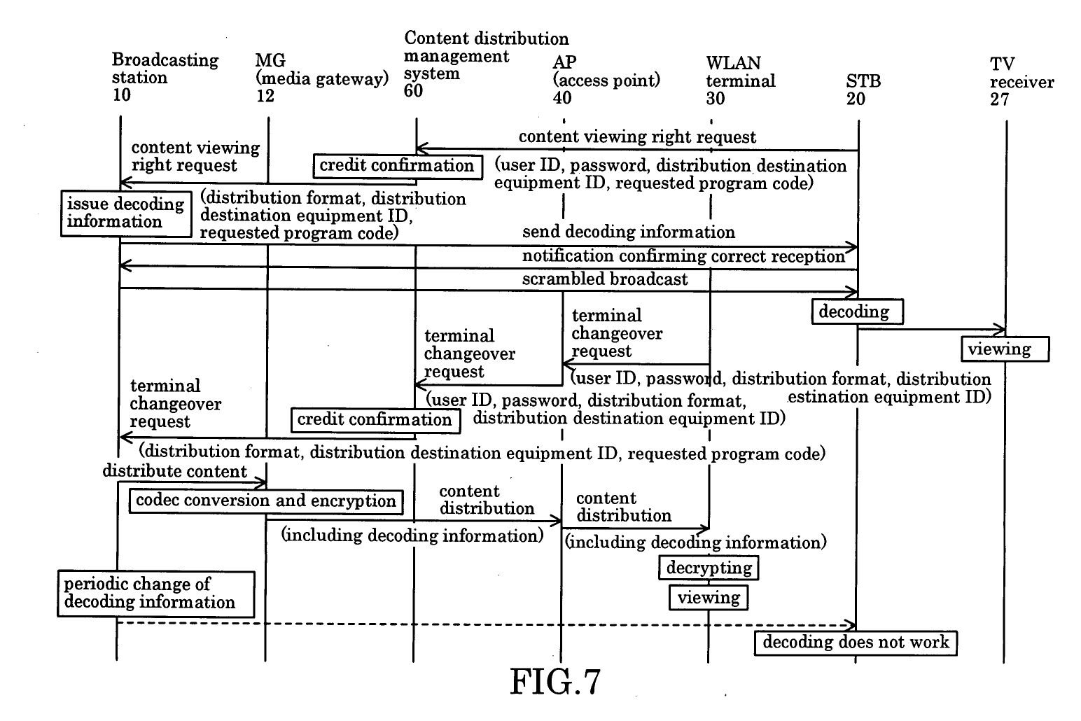

The operation of the content distribution system of the third embodiment will be described with reference to FIG. 7, which is a sequence diagram of this operation. A difference between this operation and the operation of the first embodiment is that the changeover request is issued from the terminal that will become the changeover destination.

Firstly, in similar manner to the first embodiment, a viewing request is sent from STB 20 to content distribution management system 60 via the network, this request providing the user ID, a password, the distribution destination equipment ID, the distribution format and the requested program code. After credit confirmation, content distribution management system 60 issues a viewing request to broadcasting station 10, this request including distribution format, distribution destination equipment ID and requested program code. When broadcasting station 10 receives the viewing request, it issues decoding information and sends this to the distribution destination equipment ID (i.e., to the STB) that was included in the request information that was just received. STB 20 uses the received decoding information to decode the scrambled broadcast, and views the program.

While content is being viewed at STB 20, a changeover request (user ID, password, distribution format and distribution destination equipment ID) is sent from WLAN terminal 30, to which changeover is desired, to content distribution management system 60 via the network. In this example, because the request can be made by any terminal to which changeover is desired, content distribution management system 60 does not hold information relating to changeover destination terminals. It is therefore necessary to provide the changeover destination terminal with a distribution format each time a changeover request is made.

After content distribution management system 60 has confirmed the credit of WLAN terminal 30 which issued the request, it sends a terminal changeover request (distribution format, distribution destination equipment ID and requested program code) to broadcasting station 10. When it receives this request, broadcasting station 10 uses media gateway MG 12 to convert the subscription broadcast which the user is viewing to a coding law which the requesting terminal is capable of receiving, and to encrypt the broadcast by codec conversion, and distributes the encrypted broadcast to WLAN terminal 30. Decoding information to enable decryption is also distributed to WLAN terminal 30. The method for ensuring that duplicate viewing of a program is not possible is the same as in the first embodiment.

As a result, it is not necessary to register a changeover destination terminal in advance, and hence the terminal at which a program will be viewed can be freely selected.

### Fourth Embodiment

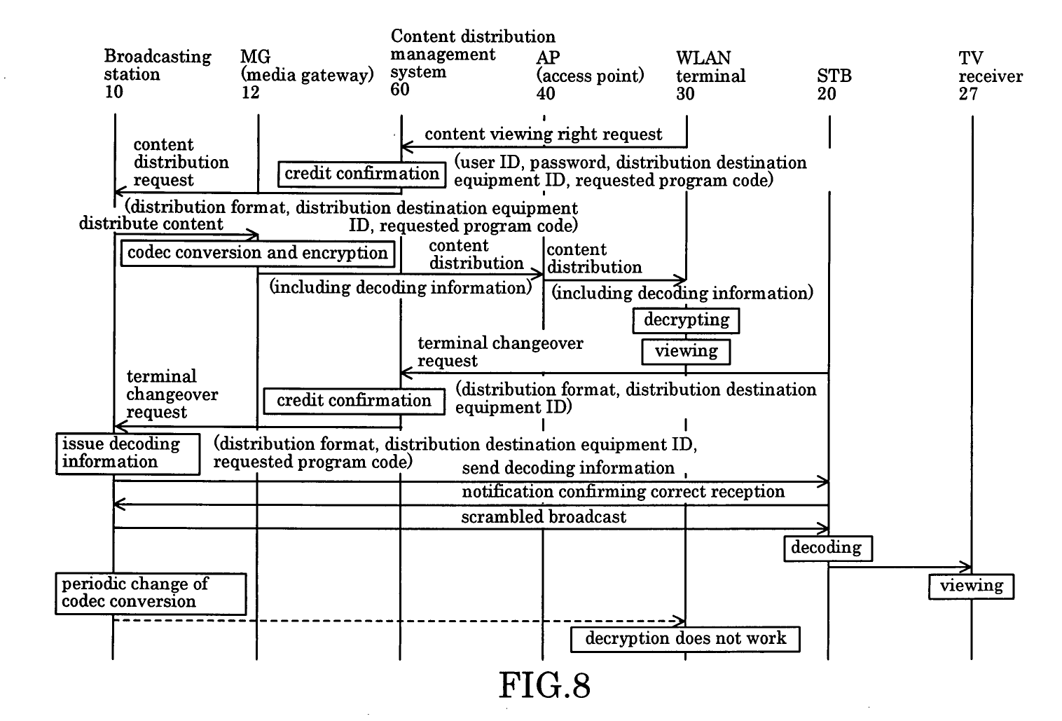

The operation of a content distribution system according to a fourth embodiment of the present invention will be described with reference to FIG. 8, which is a sequence diagram of this operation.

In this fourth embodiment, a description will be given, with reference to FIG. 8, of an example in which STB 20 changes over the content distribution destination to itself while WLAN terminal 30 is viewing a subscription broadcast. Firstly, in similar manner to the second embodiment, a viewing request is sent from WLAN terminal 30 to content distribution management system 60 via the network, this request providing user ID, a password, the distribution destination equipment ID, the distribution format and the requested program code. After credit confirmation, content distribution management system 60 issues a content distribution request (distribution format, distribution destination equipment ID, requested program code) to broadcasting station 10. When broadcasting station 10 receives this content distribution request, it uses MG 12 to encrypt the content by codec conversion and to issue decoding information, and sends these to the distribution destination equipment ID (i.e., to the WLAN terminal) that was included in the request information that was just received. WLAN terminal 30 uses the received decoding information to decode the encrypted content, and views the program.

While content is being viewed at WLAN 30, a terminal changeover request (distribution format, distribution destination equipment ID) is sent from STB 20, to which changeover is desired, to content distribution management system 60. In response to this, content distribution management system 60, after credit confirmation, sends a terminal changeover request (distribution format, distribution destination equipment ID, requested program code) to broadcasting station 10. In this example, because the request can be made by any terminal to which changeover is desired, content distribution management system 60 does not hold information relating to changeover destination terminals. It is therefore necessary to provide the changeover destination terminal with a distribution format each time a changeover request is made.

When it receives this request, broadcasting station 10 uses decoding information sending function 11 to issue decoding information, and sends this to STB 20. When STB 20 receives this, it returns to broadcasting station 10 notification confirming correct reception. Broadcasting station 10 then distributes the subscription broadcast being viewed by the user to STB 20 as a scrambled broadcast. STB 20 uses the decoding information to decode the content, which it can then view. The method for ensuring that duplicate viewing of a program is not possible is the same as in the second embodiment.

### Fifth Embodiment

The first embodiment presented an example in which STB 20 makes a terminal changeover request while STB 20 is viewing content. The second embodiment presented an example in which WLAN terminal 30 makes a terminal changeover request while WLAN terminal 30 is viewing content. The third embodiment presented an example in which WLAN terminal 30 makes a terminal changeover request while STB 20 is viewing content. The fourth embodiment presented an example in which STB 20 makes a terminal changeover request while WLAN terminal 30 is viewing content. However, it is possible to configure a content distribution system which combines all the procedures and configurations described in these first to fourth embodiments.

If this is done, all the various modes of terminal changeover will be possible, according to user requirements, thereby making the system more convenient for users.

The present invention is capable of changing over the content distribution destination between terminals which have different content receiving formats. It can therefore give users greater freedom in viewing content, and can improve the quality of a content distribution service.

1. A content distribution system comprising a broadcasting station for distributing content and a plurality of terminals for receiving said content, wherein:
said terminals comprise means for requesting changeover of distribution of said content to another terminal while viewing content from the broadcasting station;
said broadcasting station comprises means for changing over the content distribution destination on the basis of said request; and
said content distribution system comprises means for deciding on the distribution format of said content in accordance with the type of said other terminal, which corresponds to the destination to which content distribution is changed over to by said changeover means.

2. The content distribution system claimed in claim 1, wherein said means for deciding on distribution format comprises means which decides to distribute content by scrambled broadcast when said other terminal is a set-top box, and which decides to distribute content by encoded broadcast that has been encrypted by codec conversion when said other terminal is a terminal connected in a broadband environment.

3. The content distribution system claimed in claim 2, comprising means for periodically changing the scrambling pattern of said scrambled broadcast or the encryption pattern of said encoded broadcast, and their decoding information.

4. The content distribution system claimed in claim 1, wherein said terminals comprise means for displaying, in correspondence with information relating to the terminal which is currently receiving content, information relating to a terminal which can become a said destination to which distribution of content is changed.

5. A content distribution system comprising a broadcasting station for distributing content and a plurality of terminals for receiving said content, wherein:
said terminals comprise means for requesting changeover of distribution of said content to the local terminal while another terminal is viewing content from the broadcasting station;
said broadcasting station comprises means for changing over the content distribution destination on the basis of said request; and
said content distribution system comprises means for deciding on the distribution format of said content in accordance with the type of said local terminal, which corresponds to the destination to which content distribution is changed over to by said changeover means.

6. The content distribution system claimed in claim 5, wherein said means for deciding on distribution format comprises means which decides to distribute content by scrambled broadcast when said local terminal is a set-top box, and which decides to distribute content by encoded broadcast that has been encrypted by codec conversion when said local terminal is a terminal connected in a broadband environment.

7. The content distribution system claimed in claim 6, comprising means for periodically changing the scrambling pattern of said scrambled broadcast or the encryption pattern of said encoded broadcast, and their decoding information.

8. The content distribution system claimed in claim 5, wherein said terminals comprise means for displaying, in correspondence with information relating to the terminal which is currently receiving content, information relating to a terminal which can become a said destination to which distribution of content is changed.

9. A broadcasting station which is applicable to the content distribution system claimed in claim 1.

10. A terminal which is applicable to the content distribution system claimed in claim 1.
